(19) United States
(12) Patent Application Publication
(10) Pub. No.: US 2024/0217785 A1
(43) Pub. Date: Jul. 4, 2024

(54) REEVING DEVICE FOR LIFTING MACHINE AND RELATED METHODS

(71) Applicant: LINK-BELT CRANES, L.P., LLLP, Lexington, KY (US)

(72) Inventors: Derrick Wonsowski, Lexington, KY (US); Scott Bitterman, Shelbyville, KY (US)

(21) Appl. No.: 18/402,281

(22) Filed: Jan. 2, 2024

Related U.S. Application Data
(60) Provisional application No. 63/436,273, filed on Dec. 30, 2022.

(51) Int. Cl. B66C 23/62; B66C 23/42; F16G 11/10

(52) U.S. Cl. CPC B66C 23/62; B66C 23/42; F16G 11/10; B66C 2700/0371

(57) ABSTRACT

A reeving device for attaching to an end termination of a hoist rope. The reeving device includes a body with a pair of opposing ends, a central portion, and a tapered portion extending from one of the pair of opposing ends to the central portion. The body defines a cavity extending into the central portion, the tapered portion, and at least one of the pair of opposing ends. The cavity is configured to receive the end termination of the hoist rope. A tether is attached to one of the pair of opposing ends, which facilitates pulling the hoist rope using the reeving device. Related methods are also disclosed.

This application claims the benefit of U.S. Provisional Patent Application Ser. No. 63/436,273, filed Dec. 30, 2022, the disclosure of which is incorporated herein by reference.

### TECHNICAL FIELD

The present invention relates generally to a lifting machine, such as a crane, having one or more hoist ropes and, more particularly to a reeving device for a crane hoist rope and related methods.

### BACKGROUND

Various types of boom assemblies for use in cranes or other lifting devices are known in the art. Generally, conventional mobile cranes have an extendable boom assembly including base section carrying a plurality of telescoping boom sections. A hoist rope is generally extended from the rear of the boom to one or more sheaves at the boom tip, which rope is then used to lift loads in connection with the operative, extended boom. However, extension of the hoist rope from the rear of the boom to the boom tip requires a significant amount of time and effort.

### SUMMARY

According to a first aspect of the disclosure, a reeving device for attaching to an oversized end of a hoist rope is provided. The device includes a body comprising a cavity and a sidewall including a lateral opening configured to allow the oversized end of the hoist rope to enter into the cavity. The body includes a portion at least partially bounding the cavity adapted for engaging the oversized end of the hoist rope when positioned in the cavity.

In one embodiment, the device further includes a tether attached to one end of the body. The body may include an inner tapered portion at least partially bounding the cavity for engaging the oversized end of the hoist rope. The portion of the body for engaging the oversized end of the hoist rope has a width less than a width of the lateral opening.

In this or other embodiments, the body includes a pair of opposing ends, a central portion, and a first tapered portion extending from one of the pair of opposing ends to the central portion. The cavity extends within the central portion, the first tapered portion, and at least one of the pair of opposing ends. The body may further include a second tapered portion extending from at least one of the pair of opposing ends to the central portion. The central portion of the body may include a wider portion of the cavity than a width of the cavity adjacent to at least one of the pair of opposing ends.

According to a further aspect of the disclosure, a mobile crane for lifting an object using a hoist rope is provided. The mobile crane includes a boom having a first boom section and a second boom section, a hoist rope configured to traverse the first and second boom sections, and a winch for spooling and paying out the hoist rope. A reeving device includes a body for receiving and removably connecting with an oversized end of the hoist rope. A tether is connected to the body.

In one embodiment, the reeving device comprises a body having a cavity and a sidewall including a lateral opening configured to allow the oversized end of the hoist rope to enter into the cavity. The body includes a portion at least partially bounding the cavity adapted for engaging the oversized end of the hoist rope when positioned in the cavity. The opening may extend to one end of the body.

The portion of the body may comprise an inner tapered portion. The portion may also have a width less than a width of the lateral opening.

In one particular example, the body includes a pair of opposing ends, a central portion, a first tapered portion extending from one of the pair of opposing ends to the central one of the pair of opposing ends. The body may further include a second tapered portion extending from at least one of the pair of opposing ends to the central portion. The central portion of the body may have a wider portion of the cavity than a width of the cavity adjacent to at least one of the pair of opposing ends.

In accordance with yet another aspect of the invention, a method for positioning a hoist rope of a mobile crane is provided. The method includes the steps of inserting an oversized end of the hoist rope through a lateral opening into a cavity of a body, delivering the hoist rope to or from a winch, and pulling a tether attached to the body to tension the hoist rope.

In one example, the pulling step is completed during the delivering step. The method may further include the step of removing the oversized end from the cavity to disconnect the body from the hoist rope. The pulling step positions the oversized end of the hoist rope in engagement with an inner tapered portion of the body at least partially bounding the cavity. The method may further include moving the hoist rope along first and second end portions of a boom of the mobile crane.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a side view of a mobile crane, according to one or more embodiments shown and described herein;

FIG. 2 schematically depicts a side view of an end termination of the mobile crane of FIG. 1 positioned in a cavity of a reeving device, according to one or more embodiments shown and described herein;

FIGS. 2A, 2B, and 2C are cross-sectional views taken along lines 2A-2A, 2B-2B, and 2C-2C of FIG. 2, respectively.

FIG. 3 schematically depicts a side view of a boom of the mobile crane of FIG. 1, and a reeving device according to one or more embodiments shown and described herein; and

FIG. 4 depicts a flowchart for a method of using the reeving device of FIG. 2, according to one or more embodiments shown and described herein.

### DETAILED DESCRIPTION

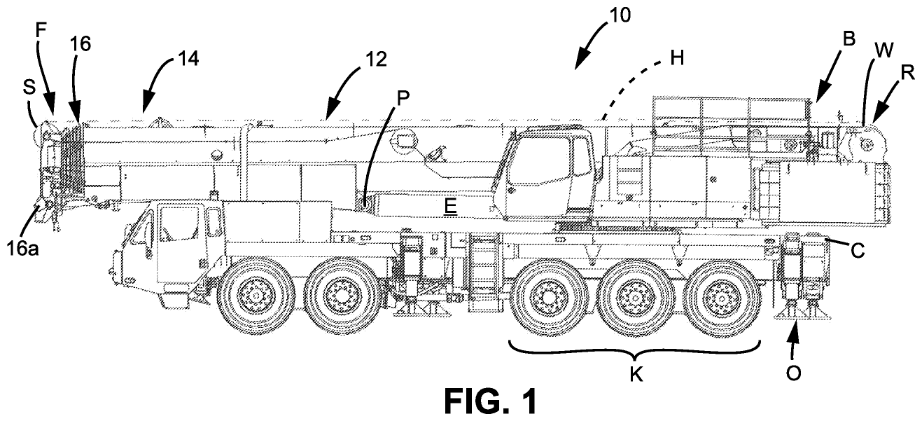

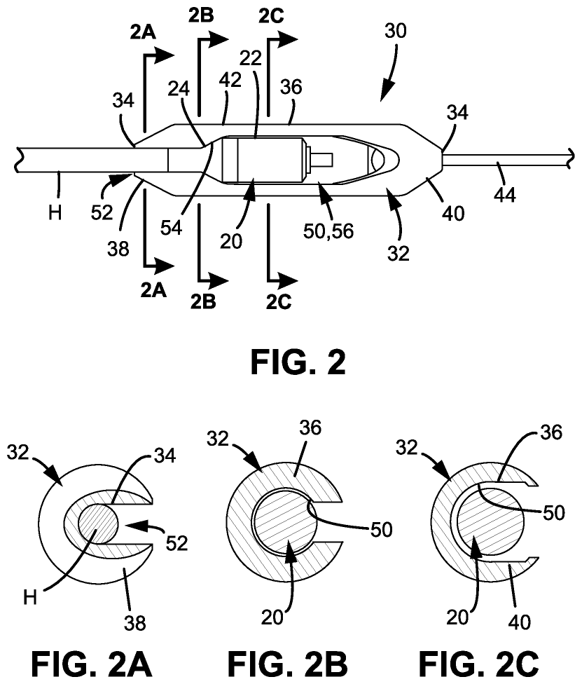

Referring to FIGS. 1 and 2, a reeving device 30 for reeving a wire rope on a boom is depicted. As depicted in FIG. 1, the boom may be attached to a mobile crane or other lifting devices known in the art. The crane 10 may include a telescoping boom assembly 12 having at least two generally tubular boom sections, such as a base section 14 and one or more extendible sections 16. The first or outer base boom section 14 is pivotally mounted on a bodily rotatable base B supported by a chassis C having ground-engaging structures (e.g., wheels K or crawler tracks or outriggers O), while extendable boom section 16 is telescopically received within the first or base boom section 14.

It should be appreciated that additional boom sections may be telescopically received within the second boom section 14 and so on. An internal hydraulic cylinder (not shown) may also be provided to move the telescoping boom sections 14, 16 relative to each other in a manner known in the art, and a lifter E, such as an external cylinder, connects with the boom assembly 12 at a connection point P, and can be used to pivot it in a vertical direction in a selective fashion to lift objects using a hoist rope H (shown in dashed line representation in FIG. 1), which may extend over one or more sheaves S at the boom head end 16a.

The crane 10 further includes a winch W for spooling and paying out the hoist rope H across the first base boom section 14 and the additional boom section 16 to the sheaves S. The winch W may be positioned at an end of the base section 14, such as at or near the connection point P, to spool and pay out the hoist rope H across the boom sections 14, 16 to the sheaves S. The hoist rope H includes an end termination 20 at an end of the hoist rope H opposite the winch W, the end termination 20 being for attaching to a hook or other mechanism for attaching to a load to lift the load using the crane 10. The end termination 20 may include a body 22 having a width that is greater than a width of the hoist rope H, and a taper 24 extending between the body 22 and the hoist rope H. The end termination 20 may be any end termination known in the art, such as, for example, a wire rope button, a wire rope wedge socket, or the like.

As can be understood from FIGS. 2, 2A, 2B, and 2C, the reeving device 30 includes a body 32 having a pair of opposed ends 34. Between the ends 34 is located a central portion 36. A first tapered portion 38 extends from one of the pair of opposing ends 34 to the central portion 36, and a second tapered portion 40 extends from the other of the pair of opposing ends 34 to the central portion 36. An outer surface 42 extends across the central portion 36 and the tapered portions 38, 40. The body 32 may be formed of a lightweight material, such as nylon, plastic, or the like.

The body 32 may define a cavity 50, an opening 52, and an inner tapered portion 54 extending between the cavity 50 and the opening 52. The cavity 50 may extend into the central portion 36 of the body 32, the first tapered portion 38, and one of the pair of opposing ends 34, where the cavity 50 is shaped to be configured to receive the end termination 20 of the hoist rope H. Along at least the central portion 36, the cavity 50 has a width that is greater than a width of the opening 52, as can be understood from FIGS. 2A and 2C.

The cavity 50 may extend into the outer surface 42 of the body 32, including the central portion 36 and the tapered portions 38, 40, to further define a cavity opening 56. The cavity 50 may extend only partially into the body 32 to permit the end termination 20 to be inserted into the cavity 50 through the cavity opening 56 and partially enclosed by the body 32 to retain the end termination 20 in contact with the reeving device 30.

The opening 52 may be positioned at one of the pair of opposing ends 34 opposite the tether 44. The opening 52 in connection with the cavity 50 is configured to allow the hoist rope H to extend there through when the end termination 20 is positioned in the cavity 50. The cavity opening 56 may extend from the central portion 36 through the first tapered portion 38 to one of the pair of opposing ends 34 of the body 32 to allow the end termination 20, along with a portion of the hoist rope H, to be inserted into the cavity 50 through the cavity opening 56. This further allows the hoist rope H to extend through the opening 52 at the one of the opposing ends 34.

The cavity opening 56 may be wider at the central portion 36 than at the tapered portions 38, 40, where a width of the central portion 36 is equal to or greater than a width of the end termination 20 to allow the end termination 20 to be inserted through the cavity opening 56. The cavity opening 56 may have a width at the first tapered portion 38 equal to or greater than a width of the hoist rope H and less than the width of the end termination 20, and also less than the width of the opening 56 along the central portion 36. This allows the hoist rope H to be inserted through the cavity opening 56, while restricting the end termination 20 from exiting the cavity 50 through the cavity opening 56 at the first tapered portion 38.

A connector, such as a tether 44, may be attached to one of the pair of opposing ends 34 (such as by being passed through an opening therein and then provided with an oversized end to capture it within the cavity 50). The tether 44 is configured to be physically manipulated by a user to pull the hoist rope H, and may be, for example, a rope extending from the body 32 that the user may grasp and pull to pull the hoist rope H. However, it is contemplated and possible that the tether 44 may comprise an attachment mechanism for attaching a rope thereto, such as a hook, carabiner, or the like. The tether 44 may be formed of a lightweight material, such as, for example, a nylon, composite rope, or the like.

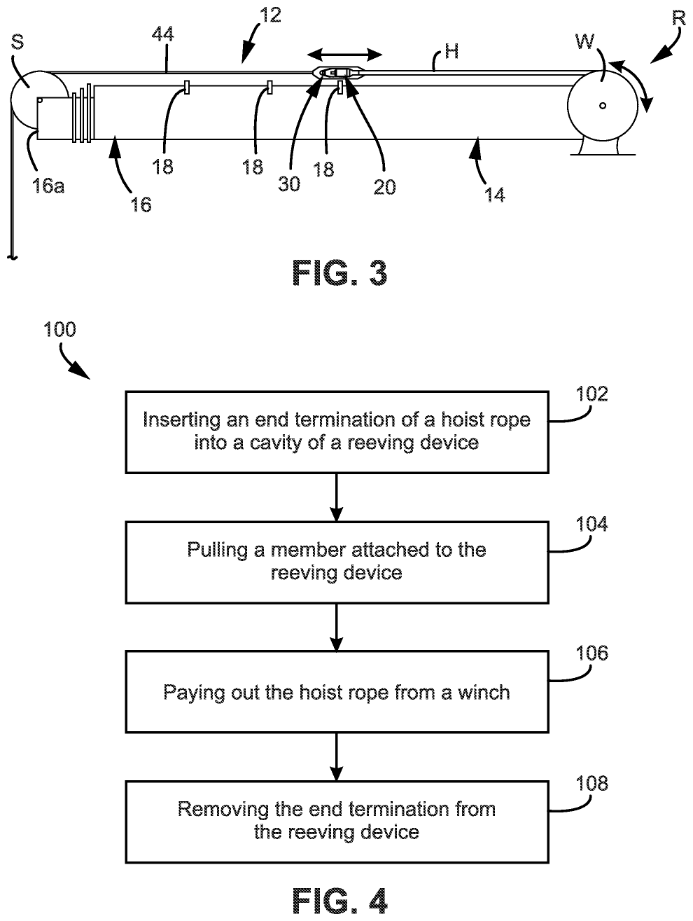

Referring now to FIGS. 3 and 4, a schematic drawing and a flowchart of a method 100 for operating the reeving device 30 are described. When the crane 10 is in an initial position with the hoist rope H spooled up by the winch W and the end termination 20 positioned at or near the winch W, the method 100 may include, at step 102, inserting the end termination 20 of the hoist rope H through the cavity opening 56 and into the cavity 50 defined by the body 32 of the reeving device 30. A portion of the hoist rope H near the end termination 20 may be inserted through the cavity opening 56 into the cavity 50 to extend from the end termination 20 through the opening 52 at the one of the opposing ends 34 of the body 32 of the reeving device 30. The tether 44 may be positioned to extend from the winch W over each of the boom sections 14, 16 to extend over the sheave S at the boom end 16a.

The method 100 may further include, at step 104, pulling the tether 44 attached to the body 32 of the reeving device 30 to tighten the hoist rope H, removing slack of the hoist rope H extending between the winch W and the reeving device 30. When the tether 44 is pulled with the end termination 20 positioned in the cavity 50 of the reeving device 30, the end termination 20 abuts the inner tapered portion 54 of the cavity 50 to be positioned away from the portion of the cavity opening 56 that has a width greater than a width of the end termination 20, and positioned adjacent the portion of the cavity opening 56 that has a width less than a width of the end termination 20, thereby preventing the end termination 20 from exiting the cavity opening 56.

When the tether 44 is pulled and slack of the hoist rope H is removed, the method 100 may include, at step 106, paying out the hoist rope H from the winch W, whereby the tether 44 is continuously pulled to prevent slack between the winch W and the end termination 20. The winch W may pay out the hoist rope H along the entire length of the boom sections 14, 16 until the end termination 20 is positioned past the boom end 16a and the hoist rope H extends over the sheave S. When moving along the boom sections 14, 16, the tapered portions 38, 40 of the body 32 of the reeving device 30 prevent the body 32 from colliding and sticking with flanges or obstacles 18 of the boom sections 14, 16, to prevent the reeving device 30 from being caught, or stuck, on the obstacles 18 of the boom sections 14, 16.

Once the hoist rope H extends over the sheave S, the method 100 may include, at step 108, removing the end termination 20 from the cavity 50 of the reeving device 30. Once the end termination 20 is removed from the cavity 50 of the reeving device 30, the end termination 20 may be attached to a load. The crane 10 may then be operated to raise and move the load as desired.

Once an operator of the crane 10 is finished using the crane 10, the steps may be repeated in the opposite order, or reversed, to spool up the hoist rope H. Specifically, the end termination 20 may be inserted into the cavity 50 of the reeving device 30 as described above. The tether 44 may be pulled to remove slack between the winch W and the end termination 20 and, once slack is removed, the method 100 may include actuating the winch W to spool up the hoist rope H until the hoist rope H and the end termination 20 are positioned at or near the winch W and connection point P.

Each of the following terms written in singular grammatical form: “a”, “an”, and the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or the context clearly dictates otherwise. For example, the phrases: “a unit”, “a device”, “an assembly”, “a mechanism”, “a component, “an element”, and “a step or procedure”, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated components), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase “consisting essentially of.” Each of the phrases “consisting of” and “consists of, as used herein, means “including and limited to”. The phrase “consisting essentially of” means that the stated entity or item (system, system unit, system sub-unit device, assembly, sub-assembly, mechanism, structure, component element or, peripheral equipment utility, accessory, or material, method or process, step or procedure, sub-step or sub-procedure), which is an entirety or part of an exemplary embodiment of the disclosed invention, or/and which is used for implementing an exemplary embodiment of the disclosed invention, may include at least one additional feature or characteristic” being a system unit system sub-unit device, assembly, sub-assembly, mechanism, structure, component or element or, peripheral equipment utility, accessory, or material, step or procedure, sub-step or sub-procedure), but only if each such additional feature or characteristic” does not materially alter the basic novel and inventive characteristics or special technical features, of the claimed item.

Terms of approximation, such as the terms about, substantially, approximately, generally, etc., as used herein, refer to ±10% of the stated numerical value or as close as possible to a stated condition.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub-combination in the context or format of a single embodiment may also be illustratively described and presented in the context or format of a plurality of separate embodiments.

Although the invention has been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A reeving device for attaching to an oversized end of a hoist rope, comprising:
a body comprising a cavity and a sidewall including a lateral opening configured to allow the oversized end of the hoist rope to enter into the cavity, the body including a portion at least partially bounding the cavity adapted for engaging the oversized end of the hoist rope when positioned in the cavity.

2. The reeving device of claim 1, further including a tether attached to one end of the body.

3. The reeving device of claim 1, wherein the body further defines an inner tapered portion at least partially bounding the cavity for engaging the oversized end of the hoist rope.

4. The reeving device of claim 1, wherein the portion of the body for engaging the oversized end of the hoist rope has a width less than a width of the lateral opening.

5. The reeving device of claim 1, wherein the body includes a pair of opposing ends, a central portion, and a first tapered portion extending from one of the pair of opposing ends to the central portion, wherein the cavity extends within the central portion, the first tapered portion, and at least one of the pair of opposing ends.

6. The reeving device of claim 5, wherein the body further comprises a second tapered portion extending from at least one of the pair of opposing ends to the central portion.

7. The reeving device of claim 5, wherein the central portion of the body includes a wider portion of the cavity than a width of the cavity adjacent to at least one of the pair of opposing ends.

8. A mobile crane for lifting an object using a hoist rope, the mobile crane comprising:
a boom having a first boom section and a second boom section;
a hoist rope configured to traverse the first and second boom sections;
a winch for spooling and paying out the hoist rope;
a reeving device including a body for receiving and removably connecting with an oversized end of the hoist rope; and
a tether connected to the body.

9. The mobile crane of claim 8, wherein the reeving device comprises a body having a cavity and a sidewall including a lateral opening configured to allow the oversized end of the hoist rope to enter into the cavity, the body including a portion at least partially bounding the cavity adapted for engaging the oversized end of the hoist rope when positioned in the cavity.

10. The mobile crane of claim 9, wherein the opening extends to one end of the body.

11. The mobile crane of claim 10, wherein the portion of the body comprises an inner tapered portion.

12. The mobile crane of claim 9, wherein the portion of the body for engaging the oversized end of the hoist rope has a width less than a width of the lateral opening.

13. The mobile crane of claim 8, wherein the body includes a pair of opposing ends, a central portion, a first tapered portion extending from one of the pair of opposing ends to the central portion, and a cavity extending within the central portion, the first tapered portion, and at least one of the pair of opposing ends.

14. The mobile crane of claim 13, wherein the body further comprises a second tapered portion extending from at least one of the pair of opposing ends to the central portion.

15. The mobile crane of claim 13, wherein the central portion of the body includes a wider portion of the cavity than a width of the cavity adjacent to at least one of the pair of opposing ends.

16. A method for positioning a hoist rope of a mobile crane, comprising:
inserting an oversized end of the hoist rope through a lateral opening into a cavity of a body;
delivering the hoist rope to or from a winch; and
pulling a tether attached to the body to tension the hoist rope.

17. The method of claim 16, wherein the pulling step is completed during the delivering step.

18. The method of claim 16, further comprising the step of removing the oversized end from the cavity to disconnect the body from the hoist rope.

19. The method of claim 16, wherein the pulling step positions the oversized end of the hoist rope in engagement with an inner tapered portion of the body at least partially bounding the cavity.

20. The method of claim 16, further comprising moving the hoist rope along first and second end portions of a boom of the mobile crane.
